(19) United States
(12) Patent Application Publication
(10) Pub. No.: US 2010/0286962 A1
(43) Pub. Date: Nov. 11, 2010

(54) SYSTEM AND METHOD OF RECORDING MEASUREMENT DATA

(75) Inventors: Hsiao-Hsien Chu, Taipei Hsien (TW); Shang-Pin Chang, Taipei Hsien (TW); Jung-Kun Hsieh, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: Cheng Uei Precision Industry Co., Ltd., Taipei Hsien (TW)

(21) Appl. No.: 12/435,588

(22) Filed: May 5, 2009

(51) Int. Cl. G06F 17/40

(52) U.S. Cl. 702/187

(57) ABSTRACT

A measurement data recording system includes a microprocessor, a first switch and a second switch. The first switch sends a trigger signal to trigger a digital measurement instrument sends a measurement data. The microprocessor detects the trigger signal aroused by the first switch, receives the measurement data, and records it into the memory card. The microprocessor also detects a trigger signal aroused by the second switch and deletes the measurement data in the memory card. A method for recording the measurement data includes steps of detecting the trigger signal, detecting a status of the memory card, detecting a status of a data file in the memory card, receiving the measurement data and recording it into the data file while the trigger signal being aroused by the first switch, and deleting the measurement data recorded in the data file while the trigger signal being aroused by the second switch.

### BACKGROUND OF THE INVENTION

1. Field of the Invention

The present invention relates to a measurement data recording system, more particularly, to a method of recording the measurement data from a digital measurement instrument into a memory card.

2. The Related Art

There are various digital measurement instruments popularly applied in factory automation, such as a vernier caliper, a micrometer, etc. In a conventional instance of operating the digital measurement instrument, the measurement data of the digital measurement instruments are manually written on the sheets and then collected as a report.

In another conventional instance of operating the digital measurement instrument, the measurement data of the digital measurement instruments are manually typed into a computer and then by running a program of the computer to calculate the measurement data to output an electronic report.

The manually recording methods described above have the following defects. It is likely to miswrite the measurement data, waste time to write and type the measurement data, and may collect the miswritten measurement data.

### SUMMARY OF THE INVENTION

An object of the present invention is to provide a measurement data recording system for receiving a measurement data from a digital measurement instrument and recording the measurement data into a memory card. The measurement data recording system includes a microprocessor, a first switch and a second switch.

The first switch is manually controlled to send a trigger signal to the digital measurement instrument and the microprocessor. The digital measurement instrument is triggered to send the measurement data to the microprocessor. The microprocessor detects the trigger signal from the first switch in order to receive the measurement data and then records the measurement data into the memory card.

The second switch is manually controlled to second a trigger signal to the microprocessor. The microprocessor also detects the trigger signal from the second switch in order to deletes the measurement data recorded in the memory card.

Another object of the present invention is to provide a method for receiving the measurement data from the digital measurement instrument and recording the measurement data into the memory card. The method includes steps of detecting the trigger signal aroused by one of the first switch and the second switch by the microprocessor, detecting a status of the memory card by the microprocessor, detecting a status of a data file recorded in the memory card, receiving the measurement data from the digital measurement instrument and then recording the measurement data into the data file recorded in the memory card while the trigger signal being aroused by the first switch, and deleting the measurement data recorded in the data file while the trigger signal being aroused by the second switch.

Thus, the measurement data recording system can quickly and correctly receive the measurement data from the digital measurement instrument, record the measurement data into the memory card, and delete the recorded data in the memory card.

### BRIEF DESCRIPTION OF THE DRAWINGS

The present invention will be apparent to those skilled in the art by reading the following description of preferred embodiments thereof, with reference to the attached drawings, in which:

FIG. 1 is a block diagram showing a measurement data recording system interconnecting to a digital measurement instrument and a memory card according to the prevent invention;

FIG. 2 is a block diagram showing a preferred embodiment of the measurement data recording system according to the present invention;

FIG. 3 shows a trigger signal aroused by a first switch and a second switch of the measurement data recording system;

FIG. 4 shows a signal of a measurement data from the digital measurement instrument;

FIG. 5 shows a first type of a frame of the measurement data and a second type of a frame of the measurement data from the digital measurement instrument;

FIG. 6 is a block diagram showing the measurement data recording system further including a logic level converter and a voltage converter according to the present invention;

FIG. 7 is a flow chart showing steps of recording the measurement data of the digital measurement instrument according to the present invention;

FIG. 8 is a flow chart showing steps of initiating the measurement data recording system according to the present invention;

FIG. 9 is a flow chart showing steps of setting a first port and a second port of the microprocessor according to the present invention;

FIG. 10 is a flow chart showing steps of determining the status of the memory card according to the present invention;

FIG. 11 is a flow chart showing steps of determining the status of a recorded data in the memory card according to the present invention;

FIG. 12 is a flow chart showing steps of recording the measurement data into the memory card according to the present invention; and

FIG. 13 is a flow chart showing steps of deleting the recorded data in the memory card according to the present invention.

### DETAILED DESCRIPTION OF THE PREFERRED EMBODIMENT

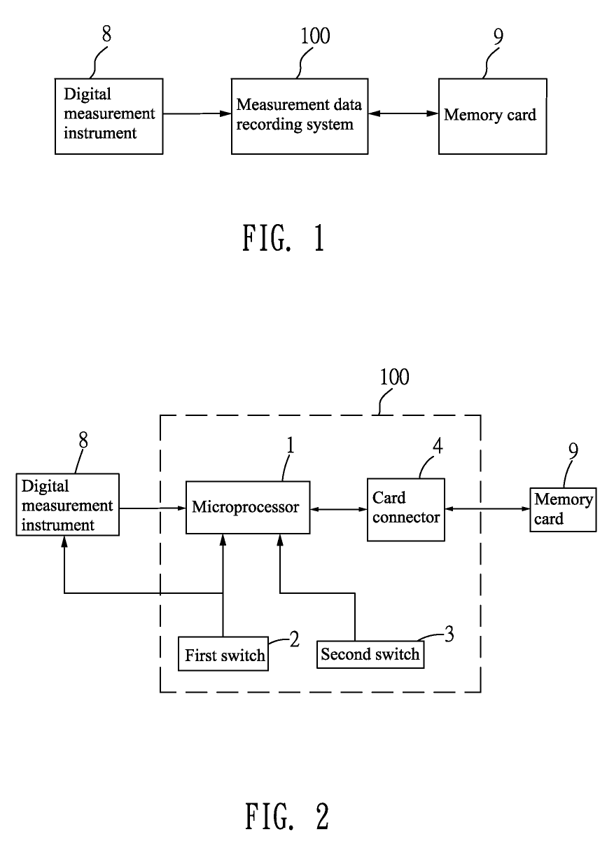

Please refer to FIG. 1, FIG. 1 shows a measurement data recording system 100 interconnecting a digital measurement instrument 8 and a memory card 9. The measurement data recording system 100 can read a measurement data from the digital measurement instrument 8 and record the measurement data into the memory card 9.

Please refer to FIG. 2, it shows a block diagram of the measurement data recording system 100. The measurement data recording system 100 includes a microprocessor 1, a first switch 2, a second switch 3 and a card connector 4. The microprocessor 1 connects the first switch 2, the second switch 3, the card connector 4 and the digital measurement instrument 8. The card connector 4 connects the memory card 9.

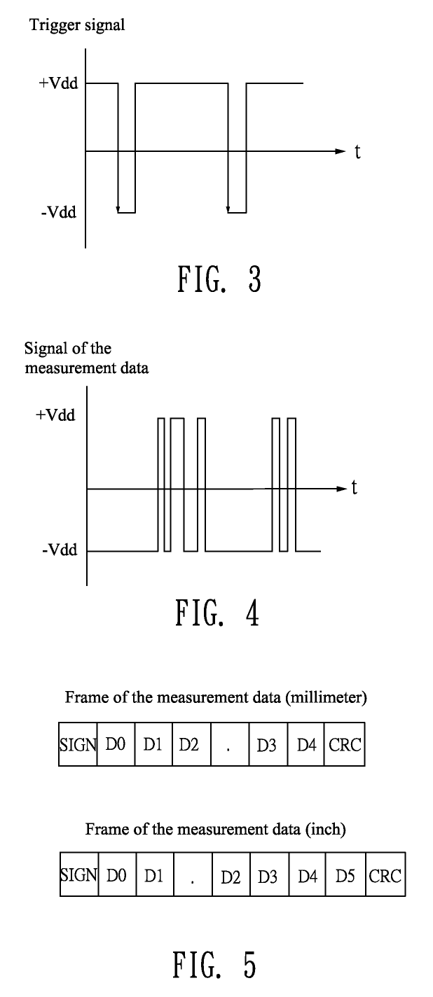

The steps of recording operation in the measurement data recording system 100 are described in afterword. The first switch 2 is controlled to send a trigger signal to the digital measurement instrument 8 and the microprocessor 1. Please refer to FIG. 3. The trigger signal is a square wave signal. Furthermore, the trigger signal is not limited to the square wave signal; it is determined by the type of the digital measurement instrument 8.

The digital measurement instrument 8 receives the trigger signal from the first switch 2 and then sends a measurement data to the microprocessor 1. Please refer to FIG. 4 and FIG. 5. FIG. 4 shows a signal of the measurement data sent from the digital measurement instrument 8. FIG. 5 shows two types of frame of the measurement data including a millimeter type and an inch type.

The microprocessor 1 receives the measurement data from the digital measurement instrument 8 while it detects the trigger signal aroused by the first switch 2. According to the trigger signal, the microprocessor 1 records the measurement data into the memory card 9 through the card connector 4. Thus, the first switch 2 functions as a record switch.

The steps of deleting operation in the measurement data recording system 100 are described in afterword. The second switch 3 is controlled to send a trigger signal to the microprocessor 1. Especially, the trigger signal from the second switch 3 may be the same trigger signal sent from the first switch 2. Moreover, the trigger signal is not limited to the square wave signal.

The microprocessor 1 deletes the measurement data recorded in the memory card 9 while it detects the trigger signal aroused by the second switch 3. Especially, the first switch 2 and the second switch 3 may be a mechanical switch or an optical switch. The first switch 2 and the second switch 3 may respond according to an outside action such as pressing the first switch 2 and the second switch 3 or moving the finger to a sensing area of the first switch 2 and the second switch 3 to send the trigger signal.

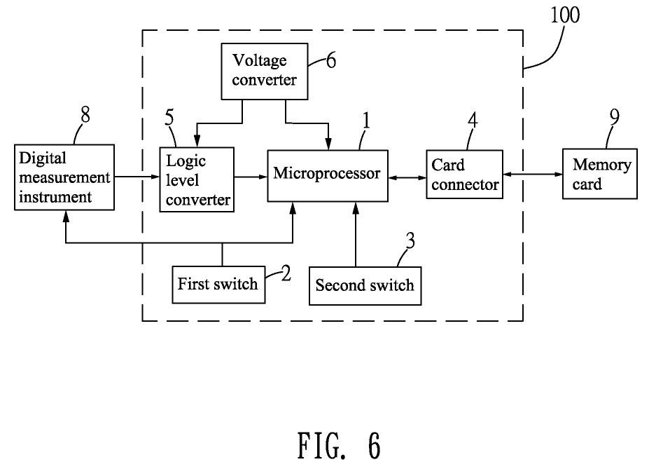

Please refer to FIG. 6. The measurement data recording system 100 further includes a logic level converter 5 and a voltage converter 6. The logic level converter 5 connects the microprocessor 1, the digital measurement instrument 8 and the voltage converter 6. The voltage converter 6 connects the microprocessor 1.

The logic level converter 5 converters the logic level of the measurement data into an acceptable logic level of the microprocessor 1 if the logic level of the microprocessor 1 and the logic level of the measurement data is different.

The voltage converter 6 converters the potential from a power supply (not shown in figures) into various potentials corresponding to the potential requirements of the microprocessor 1 and the logic level converter 5 and supplies the corresponding potentials to the microprocessor 1 and the logic level converter 5. Especially, the microprocessor 1, the first switch 2, the second switch 3, the card connector 4, the logic level converter 5 and the voltage converter 6 may dispose on a printed circuit board (not show in figures).

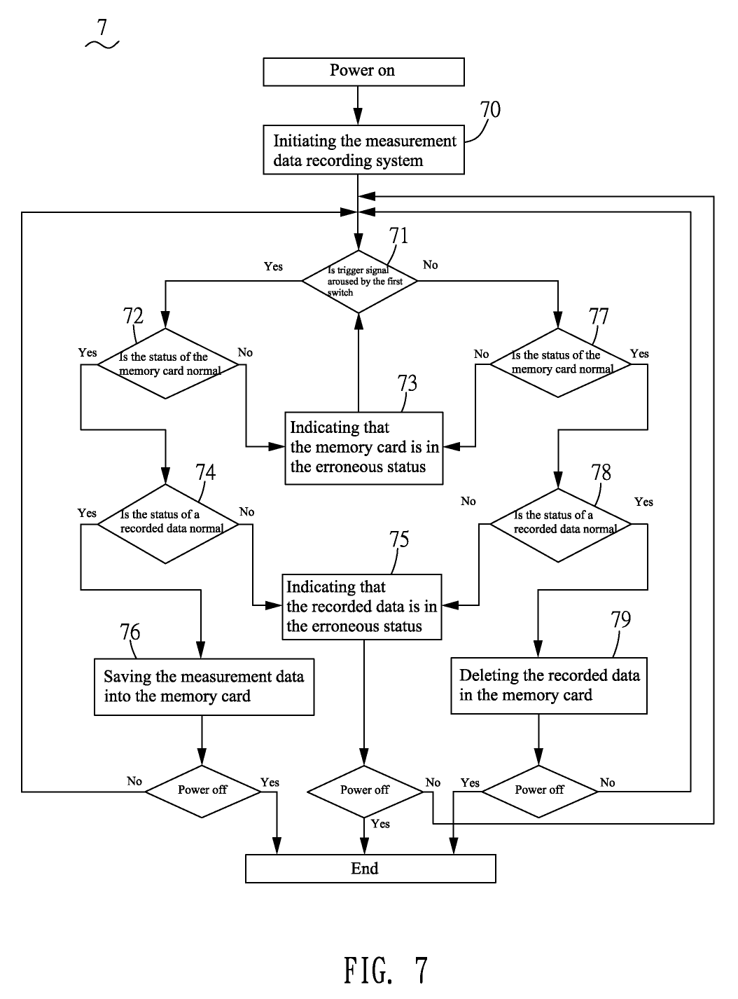

Please refer to FIG. 7, it shows a flow chart of the steps of a measurement data recording method 7. The measurement data recording method 7 includes the following steps. If the measurement data recording system 100 is powered on, the program in the microprocessor 1 is running for reading the measurement data from the digital measurement instrument 8 and recording the measurement data into the memory card 9.

In step 70, the measurement data recording system 100 is initiated. In step 71, the microprocessor 1 detects the trigger signals aroused by the first switch 2 and the second switch 3. If the trigger signal is aroused by the first switch 2, then step 72 will be executed. If the trigger signal is aroused by the second switch 3, then step 77 will be executed.

In step 72, the microprocessor 1 judges the status of the memory card 9. If the status of the memory card 9 is normal, then go to step 74. If the status of the memory card 9 is erroneous, then go to step 73. In step 73, microprocessor 1 indicates that the memory card 9 is in erroneous status, and then executes step 71. Especially, the microprocessor 1 may connect a light emitting diode and a buzzer (not shown in figures). If the status of the memory card 9 is judged as abnormal, then the microprocessor 1 will trigger the light emitting diode and the buzzer to alarm.

In step 74, the microprocessor 1 judges the status of a recorded data in the memory card 9. If the status of the recorded data is normal, then go to step 76; otherwise, go to step 75. Especially, the recorded data is a data file. Thus, the microprocessor 1 judges whether the status of the data file in the memory card 9 is normal.

In step 75, the microprocessor 1 indicates that the recorded data is in erroneous status and then executes step 71. As described above, if the status of the recorded data is erroneous, then the microprocessor 1 will trigger the light emitting diode and the buzzer to alarm. In step 76, the microprocessor 1 records the measurement data into the memory card 9 and then executes step 71.

In step 77, the microprocessor 1 judges the status of the memory card 9. If the status of the memory card 9 is normal, then execute step 78, else execute step 73. In step 78, the microprocessor 1 judges the status of the recorded data in the memory card 9. If the status of the recorded data is normal, then execute step 79; otherwise, execute step 75. In step 79, the microprocessor 1 deletes the recorded data in the memory card 9 and then executes step 71.

Furthermore, after executing the step 75, the step 76 and the step 79, the microprocessor 1 can judge the power status of the measurement data recording system 100. If the system is powered off, then the corresponding program in microprocessor 1 will be terminated, else return to the step 71.

Please refer to FIG. 8, it further shows a flow chart of initiating the measurement data recording system 100 in step 70. The method of initiating the measurement data recording system 100 includes the following steps: in step 700, setting the data transmission protocol between the microprocessor 1 and the digital measurement instrument 8, and setting data transmission protocol between the microprocessor 1 and the memory card 9.

In step 701, a file system of the memory card 9 is established. Because the compatibility among the file systems (such as FAT 16, FAT 32 and NTFS) is high, each of the above file systems will be available for the memory card 9.

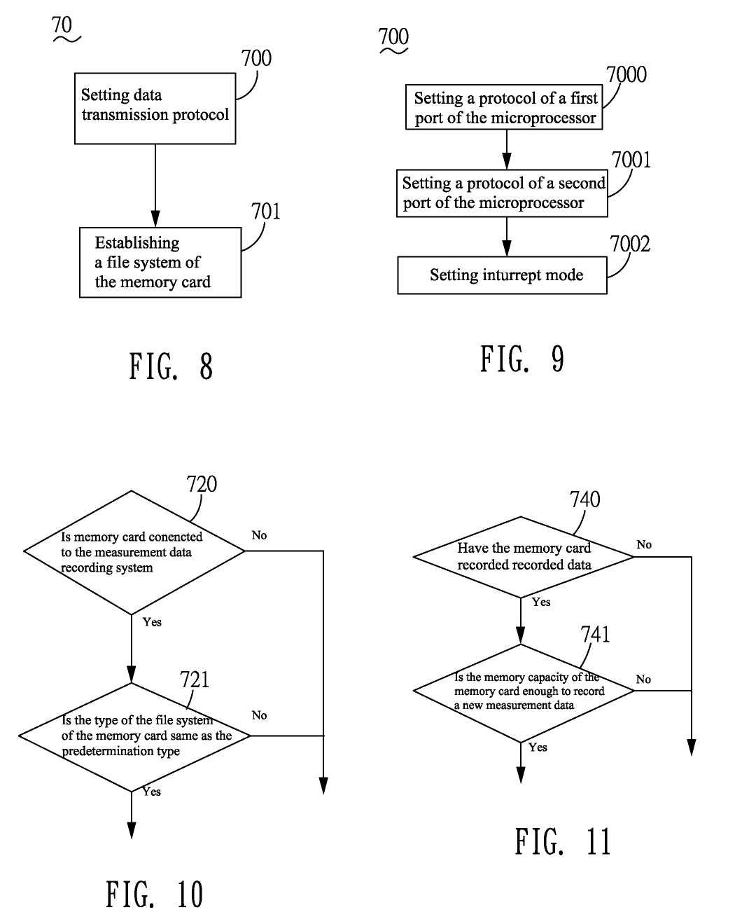

Please refer to FIG. 9, it shows a flow chart of setting data transmission protocol in step 700. In step 7000, a protocol of a first port (not shown in figures) of the microprocessor 1 is set as same as the protocol of the measurement data from the digital measurement instrument 8. In this case, the protocol of the first port of the microprocessor 1 is set to RS-232. The first port functions as a data receiving port for receiving the measurement data from the digital measurement instrument 8.

In step 7001, a protocol set in a second port of the microprocessor 1 is the same as the protocol set in the memory card 9. In this case, the memory card 9 is a secure digital (SD) card. Thus, the protocol set in the second port of the microprocessor 1 will be compatible for SD protocol or serial peripheral interface (SPI) protocol. The second port functions as a data input/output port for both sending measurement data to and receiving the recorded data from the memory card 9

In step 7002, an interrupting mode of the measurement data recording system 100 is set for detecting the trigger signal. The order between the step 700 and the step 701 can be exchanged. Moreover, the order among the step 7000, the step 7001 and the step 7002 can be exchanged.

Please refer to FIG. 10, showing a flow chart of judging the status of the memory card 9 is normal in step 72 and in step 77. In step 720, microprocessor 1 judges whether the memory card 9 is stably connected to the card connector 4. If the memory card 9 stably connects to the card connector 4, then execute step 721, else execute step 73. Especially, the microprocessor 1 sends a detection signal through the card connector 4 to the memory card 9 for judging if the memory card 9 stably connected to the card connector 4.

In step 721, the microprocessor 1 judges the file system of the memory card 9. If the file system of the memory card 9 is the same as the predetermination file system, then execute step 74 or step 78, otherwise, execute step 73. Especially, the microprocessor 1 reads the file system from the memory card 9 and then compares the type of the file system of the memory card 9 with the type of the predetermination file system.

Please refer to FIG. 11, it shows a flow chart of judging the status of the recorded data in the memory card 9 in step 74 and step 78. In step 740, microprocessor 1 judges whether the memory card 9 had recorded the data file. If the memory card 9 have recorded the data file, then execute step 741, otherwise, execute step 75. Especially, the microprocessor 1 judges the memory card 9 had recorded the data file by searching the name of the data file saved in the file system.

In step 741, the microprocessor 1 judges whether the memory capacity of the memory card 9 is large enough to record the new measurement data. If the memory capacity of the memory card 9 is large enough to record a new measurement data, then execute step 75 or the step 79, else execute step 75.

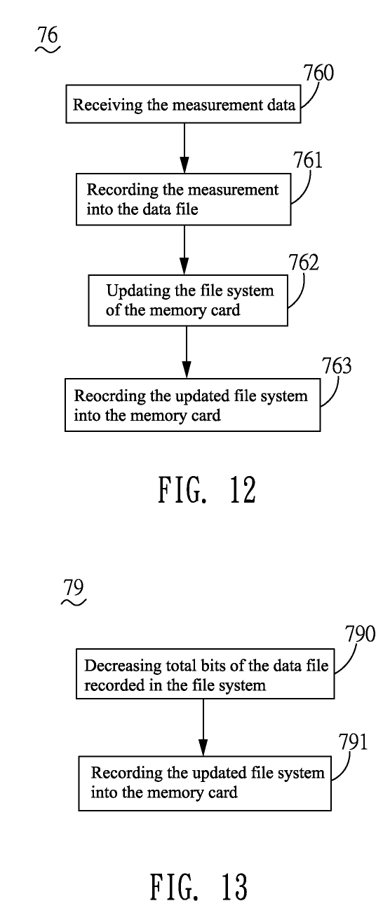

Please refer to FIG. 12, it shows a flow chart of recording the measurement data into the memory card 9 in step 76. In step 760, the microprocessor 1 receives the measurement data of the digital measurement instrument 8 through the first port. In step 761, the microprocessor 1 records the measurement data into the data file through the second port.

In step 762, the microprocessor 1 reads the file system from the memory card 9 and then updates the file system. In step 763, the microprocessor 1 records the updated file system into the memory card 9. As described above, the microprocessor 1 can trigger the light emitting diode and the buzzer to indicate that recording measurement data is complete.

Please refer to FIG. 13, it shows a flow chart of deleting the recorded data in the memory card 9 in step 79. In step 790, the microprocessor 1 decreases the total bits of the data file in the file system for deleting the recorded data in the data file. In step 791, the microprocessor 1 records the updated file system into the memory card 9. As described above, the microprocessor 1 can trigger the light emitting diode and the buzzer to indicate that the deleting measurement data is complete.

As described above, If the first switch 2 is controlled to send the trigger signal to the microprocessor 1, such as pressing the first switch 2, then the microprocessor 1 will receive the measurement data from the digital measurement instrument 8 and then records the measurement data into the memory card 9.

If the second switch 3 is controlled to send the trigger signal to the microprocessor 1, such as pressing the second switch 3, then the microprocessor 1 will delete the recorded data in the memory card 9. Therefore, the measurement data recording system 100 can soon receive the measurement data from the digital measurement instrument 8, record the measurement data into the memory card 9, and then delete the recorded data in the memory card 9.

The memory card 9 with the recorded measurement data is convenient to carry and can compatible with stand along computers and laptop computers (not shown in figures). In addition, it is easy to edit the measurement data as a report by running a program installed in the stand along computers or the laptop computers.

Furthermore, the present invention is not limited to the embodiments described above; various additions, alterations and the like may be made within the scope of the present invention by a person skilled in the art. For example, respective embodiments may be appropriately combined.

What is claimed is:

1. A measurement data recording system for receiving a measurement data from a digital measurement instrument and recording the measurement data into a memory card, comprising:
a first switch for responding a first outside action to send a first trigger signal, the digital measurement instrument responding to the first trigger signal sent from the first switch to obtain the measurement data;
a second switch for responding a second outside action to send a second trigger signal;
a microprocessor for responding the first trigger signal to access the measurement data from the digital measurement instrument, and then record the measurement data into the memory card, and responding to the second trigger signal to delete the measurement data recorded in the memory card.

2. The measurement data recording system as claimed in claim 1, further comprising a logic level converter for converting a logic level of the measurement data into an acceptable logic level of the microprocessor.

3. The measurement data recording system as claimed in claim 2, further comprising a voltage converter for converting a potential from a power supply into various potentials corresponding to potential requirements of the microprocessor and the logic level converter, and supplying corresponding potentials to the microprocessor and the logic level converter.

4. A method of receiving a measurement data from a digital measurement instrument and recording the measurement data into a memory card, comprising:
responding to a first outside action by a first switch to send a first trigger signal;
responding to a second outside action by a second switch to send a second trigger signal;
responding to the first trigger signal by the digital measurement instrument to obtain the measurement data;
responding to the first trigger signal by a microprocessor to access the measurement data, a detect a status of the memory card and detect a status of a data file recorded in the memory card, and then record the measurement data into the data file in the memory card;
responding to the second trigger signal by the microprocessor to delete the measurement data recorded in the data file.

5. The method as claimed in claim 4, further comprising the steps:
setting a protocol of a first port of the microprocessor the same as a protocol of the digital measurement instrument in order to receive the measurement data;
setting a protocol of a second port of the microprocessor the same as a protocol of the memory card in order to record the measurement data into the memory card;
setting a means of the microprocessor for detecting the first trigger signal and the second trigger signal; and
setting a predetermination file system into the memory card.

6. The method as claimed in claim 5, wherein the protocol set in the first port is the same as which set in RS-232.

7. The method as claimed in claim 5, wherein the protocol set in the second port is the same as which set in serial peripheral interface.

8. The method as claimed in claim 5, wherein the file system in the memory card is one of the FAT 16, FAT 32 and NTFS.

9. The method as claimed in claim 5, wherein the step of detecting the status of the memory card further comprises:
detecting an electrical connection between the microprocessor and the memory card;
reading the file system of the memory card; and
comparing the type of the file system of the memory with the type of the predetermination file system.

10. The method as claimed in claim 5, wherein the step of detecting the status of the data file further comprises:
reading the file system of the memory card;
searching a name of the data file recorded in the file system; and
detecting a remainder memory capacity of the memory card.

11. The method as claimed in claim 5, wherein the step of recording the measurement data into the memory card further comprises:
reading the file system of the memory card;
recording the measurement data into the data file in the memory card;
updating the file system read from the memory card; and
recording the updated file system into the memory card.

12. The method as claimed in claim 5, wherein the step of deleting the measurement data recorded in the memory card further comprises:
reading the file system of the memory card;
decreasing total bits of the data file recorded in the file system; and
recording the updated file system into the memory card.
